(19) United States
(12) Patent Application Publication
(10) Pub. No.: US 2007/0185734 A1
(43) Pub. Date: Aug. 9, 2007

(54) Using diagnoses to identify adults with disabilities

(76) Inventors: Susan Palsbo, Eugene, OR (US); Margaret F. Mastal, Alexandria, VA (US)

Correspondence Address: GEORGE MASON UNIVERSITY;OFFICE OF TECHNOLOGY TRANSFER, MSN 5G5, 4400 UNIVERSITY DRIVE, FAIRFAX, VA, 22030, US

(21) Appl. No.: 11/654,608

(22) Filed: Jan. 18, 2007

Related U.S. Application Data
(60) Provisional application No. 60/759,553, filed on Jan. 18, 2006.
(60) Provisional application No. 60/763,911, filed on Feb. 1, 2006.

(51) Int. Cl. G06Q 10/00; G06F 19/00; G06F 7/00

(52) U.S. Cl. 705/2; 707/102; 705/3

(57) ABSTRACT

Individuals with disabilities may be classified under a particular health risk level using an access risk classification system based on nonstatistical risks. This computer methodology and system collects and aggregates medical data, which includes a person identifier and the person identifier's medical codes. By applying a data mining technique, each person identifier's medical codes can be assigned a highest access risk level, which in turn, may be used to classify the person identifier.

### CROSS REFERENCE TO RELATED APPLICATIONS

The present application claims the benefit of provisional patent application Ser. No. 60/759,553 to Palsbo et al., filed on Jan. 18, 2006, entitled “Using Diagnoses to Identify Adults with Disabilities,” and provisional patent application Ser. No. 60/763,911 to Palsbo et al., filed on Feb. 1, 2006, entitled “Using Diagnoses to Identify Adults with Disabilities,” both which are hereby incorporated by reference.

### GOVERNMENT LICENSE RIGHTS

This invention was made with government support under Grant No. H133A030804 awarded by the National Institute on Disability and Rehabilitation Research, U.S. Department of Education. The government has certain rights in the invention.

### REFERENCE TO COMPUTER PROGRAM LISTING APPENDIX ON A COMPACT DISC

Two copies of a single compact disc (Compact Disc), labeled Copy 1 and Copy 2, are hereby incorporated by reference in their entirety. Each Compact Disc contains Computer Program Listing Appendix A (created on Compact Disc on Jan. 18, 2007 and having a size of 18,654 bytes), which contains the Access Risk Classification Algorithm.

### BRIEF DESCRIPTION OF THE DRAWINGS

FIG. 1 shows an example of a block diagram of an access risk classification system.

FIG. 2 shows another example of a block diagram of an access risk classification system.

FIG. 3 shows an example of a flow diagram of an access risk classification system.

FIG. 4 shows another example of a flow diagram of an access risk classification system.

### DETAILED DESCRIPTION OF THE INVENTION

The claimed invention relates to an access risk classification system (ARCS) that may be embodied as systems, methods and/or computer program products (e.g., software, hardware, etc.).

I. Introduction

Significant disparities regarding access to care for people with disabilities, even for those enrolled in a managed care organization (MCO), have recently been uncovered. It is likely the case that such disparities arise from other reasons other than financial barriers. If health care organizations, including state Medicaid programs, MCOs and medical clinics, can identify people who are at risk of not receiving services they need, the organizations can establish outreach programs to identify and redress the root causes of access disparities for people with disabilities.

MCOs currently identify adults with disabilities using three known mechanisms. One is surveying and self-reports. Another is in-person assessments and medical chart review. A third is extraction of information from computerized administrative data.

The first mechanism, relying on surveys, however, can present a couple of drawbacks. Surveying the entire population to identify a small percentage of people with new cases of disabilities is costly and highly inefficient. Additionally, for those who are identified, they may not be able to respond because of an impaired function, cognition or reluctance of identifying oneself as a person with a disability.

Despite these drawbacks, many affinity groups and external review agencies, such as state Medicaid departments, rely on surveys to obtain consumer reported measures regarding the quality of care and access. For example, the Foundation for Accountability (FACCT) has developed a five-question screening tool to identify adults with special health care needs (SHCNs). This adult screener identified approximately 36 percent of a Temporary Aid to Needy Families (TANF) sample, which was predominately females (˜92%) between ages 18 and 45, as having a chronic condition or special health care need. Individuals identified by the FACCT adult SHCN screener defined dramatically and significantly from those not identified in terms of overall health status, level of disability, and functional limitations, and in their need for or use of services. Affinity groups tend to also rely on self-reports, such as a national registry for multiple sclerosis.

The second mechanism, relying on in-person assessments and medical chart review, also has drawbacks. One, they are usually time-consuming. They also tend to be costly. Furthermore, they appear unrealistic for claims-paying health organizations or state Medicaid departments that do not directly provide health care services.

The third mechanism for case identification involves minimizing computerized health care administrative data, especially hospital, office visit and pharmacy claims. This method is espoused by the National Committee on Quality Assurance to identify MCO enrollees with diabetes or asthma. Yet, like the other two mechanisms, this one also has some drawbacks. Examples of drawbacks include costs of funding new computers to replace obsolete computer technologies and maintain existing computers, costs of hiring and/or training technicians, and addressing patients' questions and/or concerns about the possibility that computers are replacing doctors.

Because of these drawbacks, a technique to help health care providers and organizations more properly identify individuals with disabilities is needed. While a study has been published using administrative claims data to identify and categorize people with disabilities, it looked at children with chronic conditions and other special health care needs. See J. M. Neff et al., 2 Ambulatory Pediatrics 71-79 (2002); see also C. D. Bethell, 2 Ambulatory Pediatrics 49-57 (2002). However, it would be helpful to have a technique that tests the feasibility of using administrative data to identify adults of working age with disabilities.

II. Access Risk

Current predictive models in the field of health and medical applications are typically based on statistical risks. Unlike those models, the present invention teaches a unique predictive model using nonstatistical risks. The computer based methodology of using a nonstatisical risk predictive model can generally help health providers in determining the amount of care and/or treatment recommended or needed for each diagnosis.

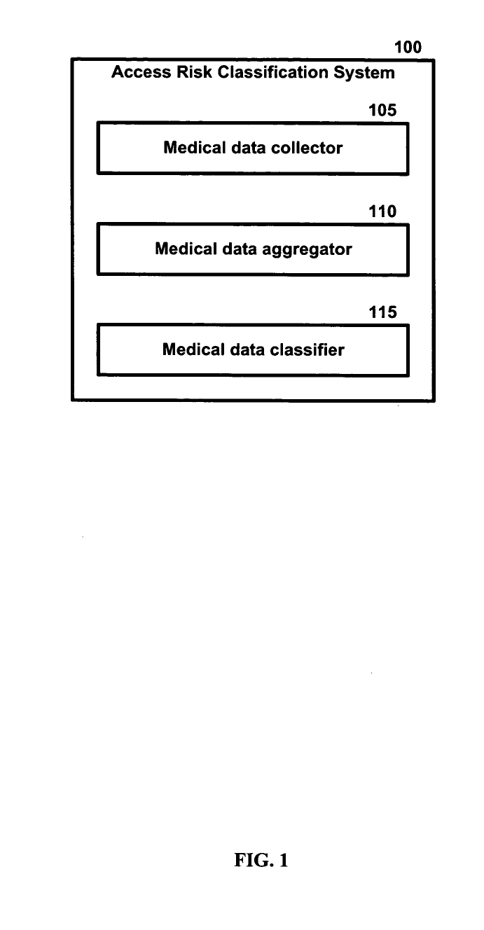

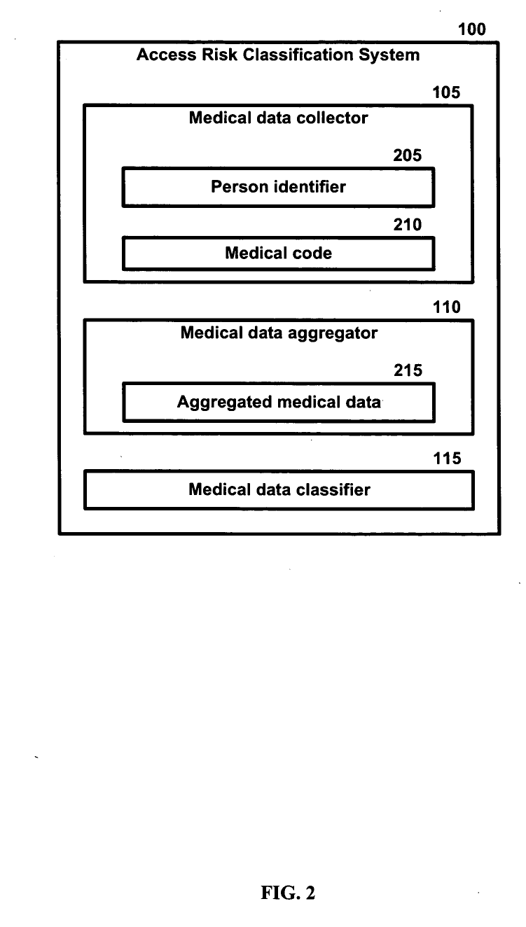

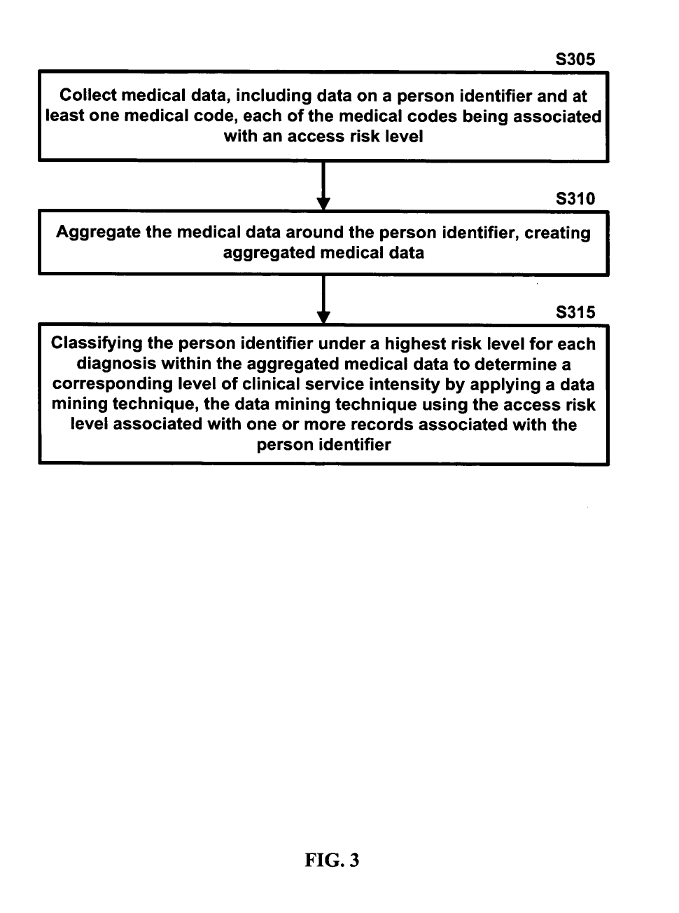

FIGS. 1-4 show examples of ARCS 100. ARCS 100 may be contained in a tangible computer readable medium (e.g., computer program product, etc.). The tangible computer readable medium may be encoded with instructions for classifying an individual with disabilities that are executable by an instruction execution system. Additionally, tangible computer readable medium may be encoded with instructions for using diagnoses to identify adults with disabilities.

Examples of tangible computer readable mediums include, but are not limited to, a compact disc (cd), digital versatile disc (dvd), usb flash drive, floppy disk, random access memory (RAM), read-only memory (ROM), erasable programmable read-only memory (EPROM), optical fiber, etc. It should be noted that the tangible computer readable medium may even be paper or other suitable medium in which the instructions can be electronically captured, such as optical scanning. Where optical scanning occurs, the instructions may be compiled, interpreted, or otherwise processed in a suitable manner, if necessary, and then stored in computer memory.

In one aspect of the present invention, as shown in FIGS. 1, 2 and 3, the instructions may include collecting medical data S305. Collection may be achieved using a medical data collector 105. Among the information that may be included in the medical data are a person identifier 205 and one or more medical codes 210. The medical code 210 may be associated with one or more access risk levels. For example, access risk levels include, but are not limited to, level 0, level 1, level 2 and level 3. Medical data may be aggregated using a medical data aggregator 110 around the person identifier to create aggregated medical data 215, S310. Using a medical data classifier 115, the person identifier 205 may be classified into the highest access risk level for each diagnosis within the aggregated medical data 215 to determine the corresponding level of clinical service intensity S315. Classification may be accomplished using a data mining technique. The data mining technique may incorporate access risk levels associated with one or more records that are associated with the person identifier 205.

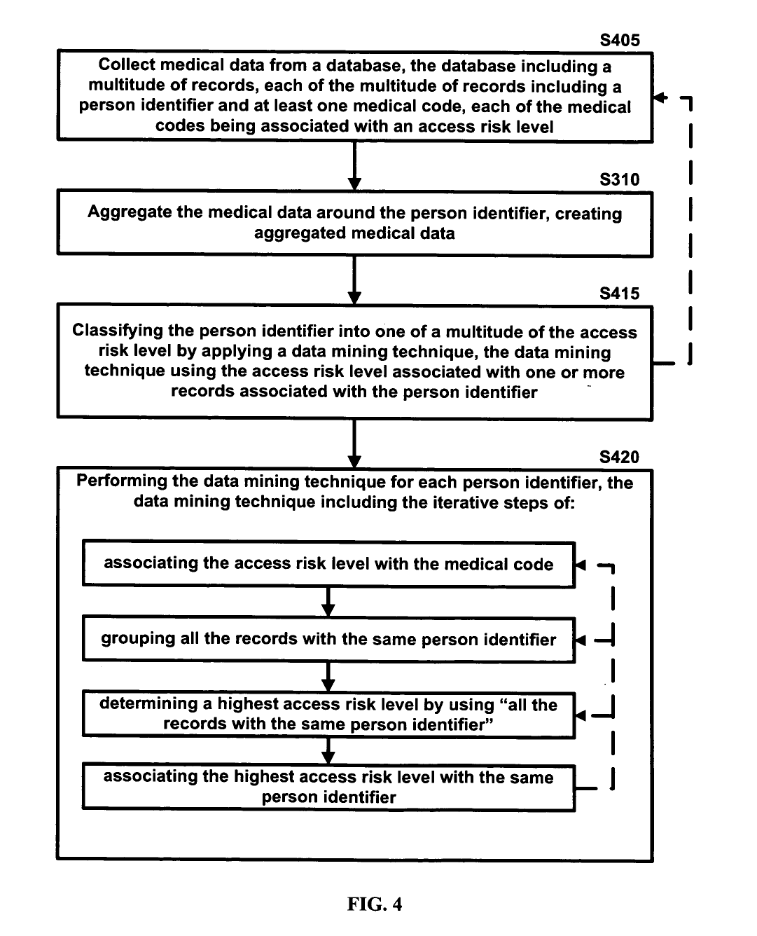

In further aspect of the present invention, as shown in FIG. 4, using a computer or other device, the data mining technique may, for each person identifier, associate access risk levels with one or more medical codes, group records, determine the highest risk level using the grouped records and classify the same person identifier with the highest risk level S420. It may be the case that this aspect is performed iteratively. Furthermore, as indicated by dashed lines in step S420, it may be the case that not every step needs to be performed for any iteration.

Moreover, as indicated by dashed lines from S415 to S405, it may be desired to repeat data collection and aggregation for each person identifier or for a certain number of person identifiers before ultimately performing the data mining technique for each person identifier.

It should be noted that the terms “individual” and “person identifier” mean the same person and may be used interchangeably.

The instructions may be written using any computer language or format. Nonlimiting examples of computer languages include Ada, Ajax, C++, Cobol, Java, Python, XML, etc.

The instruction execution system may be any apparatus (such as a computer) or “other device” that is configured or configurable to execute embedded instructions. Examples of “other device” include, but are not limited to, PDA, cd player/drive, dvd player/drive, cell phone, etc.

A. Classifying Medical Data

An individual's medical data may be collected over a period of time S305. Medical data may be collected from paper records or a database having a multitude of records that, inter alia, may contain the individual's identity 205 and any medical code 210 relating to the individual's medical history S405. Alternatively, medical data may be streamlined online, into a database or into the ARCS program.

Generally, the medical code 210 may be used to assign an estimated level of clinical service intensity to a diagnosis. The medical code 210 is defined as any health, health-related or medical code recognized and/or used by the government, medical and/or healthcare providers, health insurance organizations, maintenance care organizations, etc. Examples of such codes include, but are not limited to, those by the International Classification of Diseases (ICD) (such as ICD, Ninth Revision, Clinical Modification (ICD-9-CM)), Healthcare Common Procedure Coding System (HCPCS), Current Procedural Terminology (CPT), National Drug Code (NDC), etc. Alternatively, if no code can be listed, the medical code 210 may be identified as “no code.”

Clinical service intensity (and also “level of clinical service intensity”) is defined as the person identifier's risk classification. The clinical service intensity is designed to correspond to at least one access risk level. As an embodiment, similar to the nonlimiting examples of access risk levels, the present invention also allows for nonlimiting examples of clinical service intensities. For instance, if a total of five access risk levels exist, then there may be three or five or eight corresponding clinical service intensities. In other words, the number of access risk levels need not equal the number of corresponding clinical service intensities.

Diagnosis is defined as any diagnosis, procedure, equipment and/or medication.

As another embodiment, in addition to the individual's medical code, the number of different prescriptions and/or medications may also be collected and/or tallied.

Collected medical data may be aggregated S310. Using aggregated medical data 215, the level of clinical service intensity for the person identifier 205 for each medical code may be determined in at least two ways.

In one embodiment, the person identifier 205 may be classified under the highest access risk level for each medical code. Classification may be achieved by applying a data mining technique, which uses the access risk level associated with one or more records associated with the person identifier S315.

In another embodiment, rather than being directly classified under the highest access risk level, the person identifier 205 is classified into one of a multitude of access risk levels S415. As above, classification may also be achieved by applying a data mining technique that uses the access risk level(s) associated with one or more records associated with the person identifier 205. If repetition is desired, the steps of collecting medical data, aggregating medical data and classifying the person identifier 205 into an access risk level may be repeated for each or certain number of person identifiers 205. The administrator or user (who herein may also be the administrator) of the ARCS program may have the ability to determined the number of person identifiers 205. Once data is collected for the desired person identifiers 205, the data mining technique may be iteratively performed for each person identifier S420. Iterative steps include associating the access risk level with the medical code 210, grouping all the records with the same person identifier 205, determining the highest access risk level by using “all the records with the same person identifier” 205, and associating the highest access risk level with the same person identifier 205, S420. Iteration may occur for one, some or all of the steps in step S420.

Each access risk level corresponds to at least one level of clinical service intensity. Clinical service intensities may help stimulate awareness among health providers for the level of required medical attention.

Access risk level may be assigned to a medical code 210 processing one or more codes. Codes that may be processed include, but are not limited to, ICD, CPT, HCPCS, NDC and “no code” over a predetermined period of time (e.g., six months, a year, five years, etc.). The predetermined period of time may be set by the ARCS user.

To maintain consistency, an embodiment of the present invention is having a certain number of access risk levels to serve as a standard. As those skilled in the art can appreciate multiple levels can be used, the present invention may be illustrated with 4 different access risk levels, ranging from level 0 to level 3. If the individual's highest access risk level is 0, then no intervention needs to be made. If the individual's highest access risk level is 1, the individual should be contacted at least once per year to assess current health system needs. If the individual's highest access risk level is 2 or 3, the individual should be contacted by a health practitioner at that individual's residence for exact classification. If classified at level 2, the individual should be contacted at least quarterly. If classified at level 3, the individual may need to be monitored bi-weekly or more frequently.

As exemplified in TABLE 1, access risks may be characterized into an access risk level having a corresponding level of clinical service intensity.

TABLE 1
Access Risk Levels and Clinical Service Intensity

| Access Risk Level | Clinical Service Intensity |
|---|---|
| Level 0 | None/No risk |
| Level 1 | Low clinical intensity/Low risk |
| Level 2 | Medium clinical intensity/Medium risk |
| Level 3 | High clinical intensity/High risk |

Level 0, “None” or “No risk” means acute care. Examples of medical attention that qualify under this level include, but are not limited to, injuries, poisonings, evaluation and management, pregnancy, etc.

Level 1, “Low clinical intensity” or “Low risk” means chronic condition that is medically stable. Examples of medical attention that qualify under this level include, but are not limited to, arthritis, early stages of multiple sclerosis, legal blindness, controlled diabetes, etc.

Level 2, “Medium clinical intensity” or “Medium risk” means chronic conditions where an individual can benefit from service coordination. Examples of medical attention that qualify under this level include, but are not limited to, spinal cord injury, post-polio syndrome, intermediate stages of multiple sclerosis, emotional dysfunction, slight cognitive impairment, impaired speech, psychiatric conditions which an individual can manage with medication, uncontrolled diabetes, etc.

Level 3, “High clinical intensity” or “High risk” means comprehensive care coordination needed to provide skilled nursing services and personal care assistance on a continuous basis. Examples of medical attention that qualify under this level include, but are not limited to, spinal cord injury with traumatic brain injury and diabetes, advanced stages of multiple sclerosis, complex comorbidities, etc.

The individual may be classified under the highest access risk level by using a data mining technique. As an embodiment, the data mining technique uses a predetermined formula, which may incorporate a Delphi Research Method and any equivalent method to obtain a consensus on the intensity level for each diagnosis code. The predetermined formula is the Access Risk Classification Algorithm of Appendix A. It should be noted that the predetermined formula can operate by using the access risk level associated with one or more records associated with the individual.

Where a diagnosis spans at least two levels of clinical service intensities, a range of levels may be assigned (e.g., Level 1 and Level 2, Level 2 and Level 3, or Level 1, Level 2 and Level 3). This range may depend on the stage and manifestations of the disease, such as multiple sclerosis or spinal cord injury. Hence, some diagnoses may be partially assigned to, for example, two levels. For each diagnosis resulting in partial assignments, the average of the levels may be designated (such as 2.5). To obtain the intensity level for such diagnosis, the predetermined formula, like above, may also be used.

Generally, people with disabilities may have multiple encounters with health providers during a year. For those with some kind of health insurance, they may have multiple diagnostic codes in the insurer's claims database. To assign an indicator of access risk class using these codes, all diagnoses, procedure codes, equipment codes and medication codes for each person may be retrieved. Each person's access risk level may be observed for one or more codes for a particular time period (e.g., one week, six months, one year, five years, etc.). Each individual may also be assigned to a single risk class based on the highest risk level for any of the diagnosis, procedure, equipment or medication that appeared over the particular time period.

As shown in TABLE 2, the risk(s) associated with a specific code may be assigned. Among the risks associated, the ARCS level may be assigned based on the highest of any risk associated with the specific code. The corresponding clinical service intensity (also referred to herein as “access risk class”) may be the highest of any of the codes. For example, suppose Code 1 shows nineteen risks varying from zero to three. In this case then, the person's highest access risk class would be a three. As another example, suppose Code 1 shows one risk listed at two. Then, the person's highest access risk class would be a two.

TABLE 2
Example of Assignment of Access Risk Classification

| | Code 1 | Code 2 | Code 3 | Code 4 |
|---|---|---|---|---|
| Unique Code | (e.g., | (e.g., | (e.g., | (e.g., diagnosis |
| Mention | diagnosis) | procedure) | medication) | #2) |
| Risk | 0 | 2 | 3 | 2 |
| associated | | | | |
| with specific | | | | |
| code | | | | |
| ARCS Level | Highest of any | | | |
| | risk associated | | | |
| | with specific | | | |
| | code (e.g., 3) | | | |

At times, a person identifier may have recurring or a vast amount of diagnoses under a specific code. Having to determine the person identifier's classification under such scenario may be timely and/or costly. Hence, as an embodiment, the present invention allows for a predetermined amount of predetermined codes (e.g., medical codes 210) to serve as a maximum. This amount may be set by the administrator or user. For example, the predetermined amount may be fifteen prescription counts or eight diagnosis counts. When such amount is exceeded (e.g., a sixteenth prescription count, a ninth diagnosis count, etc.), the highest access risk level may be assigned according to those falling within the predetermined amount (e.g., the first fifteen prescription counts, the first eight diagnosis counts, etc.). Any excess beyond the predetermined amount may be ignored. However, as another embodiment, the predetermined amount may be modified at any time to allow for an increase or decrease in the amount of counts.

B. Validating Classified Medical Data

ARCS may be validated against a patient's self-report. For instance, validation may be conducted by a health maintenance organization (HMO) care coordination nurse. As an embodiment, it is preferable that the HMO provide as much comprehensive care as possible with relatively little care provided outside the patient's health plan. An additional embodiment is that the HMO should electronically document care.

Validation may also be accomplished using a sampling strategy, such as a stratified random sampling strategy. The sampling universe of the sampling strategy is defined to include a multitude of factors set according to a user's preferences. Factors include, but are not limited to, the number of randomly selected individuals to complete the survey, age, Medicaid eligibility, enrollment date, gender, residence, area code, type of employment, known personal and/or family health problems, medication (prescription and/or nonprescription), payment source characteristics, income level, daily activities, mobility problems, etc.

In one embodiment, the sampling universe includes adults ranging from ages 18 to 64.

1. Experimental Example

The following experiment shows how ARCS may be implemented. However, it should be noted that this experiment neither demonstrates the features and embodiments of the present invention as the only possible representation nor limits the applications for which ARCS may apply.

In one example, where Inland Empire Health Plan (IEHP) was selected and tested, there were approximately 23,688 Medicaid beneficiaries age 18 or over, who were not in hospice, who read English, and who were enrolled for the entire 12 calendar months of 2004. It was determined that about 68% of the IEHP adults fell into access risk level 0 or 1 (e.g., no risk or low risk).

Applying ARCS, a certain percentage of people within each level (e.g., Levels 0-3) may be sampled. For example, the following groups for this scenario were surveyed: (a) 100% of people with the highest intensity (Level 3), (b) 100% of people with medium intensity (Level 2), (c) 66% of people with low intensity (Level 1) and more than 14 prescriptions, (d) 40% of people with low intensity (Level 1) and fewer than 15 prescriptions, (e) 45% of people with no intensity (Level 0) and more than 14 prescriptions, and (f) 20% of people with no intensity (Level 0) and fewer than 15 prescriptions.

Individuals having an ARCS Level of 0 or 1 may also be surveyed. It may be necessary to perform this task to determine whether the ARCS was incorrectly identifying people as not encountering access barriers resulting from functional impairment, when, in fact, they were. A sampling frame may be developed to carry out this task. The sampling frame may use similar factors as those in the sampling universe, such as age, gender or number of prescriptions. The survey may be completed by a certain number of randomly selected individuals (e.g., 1,000).

The survey may be conducted using any known surveying instrument, such as the Consumer Assessment of Health Plan Survey (CAHPS), a health provider's health status questionnaire or an equivalent. CAHPS is generally designated to screen adults without disabilities. However, a CAHPS module for people with mobility impairments is under development by the Agency for Healthcare Research and Quality. It may also include questions about function. Nonlimiting examples of such questions include: OARS mobility scale; activities of daily living (ADL); instrumental activities of daily living (IADL); mobility problems; depression; severe memory problems; sensory impairments; complex health care needs; complex medical supports; special equipment; caregiving needs; caregiving responsibilities and health problems. The CAHPS may also include instructions to proxy respondents for persons who are unable to complete an optical scanning questionnaire.

2. Experimental Results

a. Descriptive Analysis

Of the 1,595 survey respondents, ˜37% of the respondents had severe disabilities, ˜19% had no disabilities, and the balance had some disabilities. Approximately half of the respondents used more than 10 medications. The respondents were disproportionately female (˜82%) and adults of working age (ages 20-59) (˜96%), but reflected the makeup of the study HMO. Nearly half (49%) of respondents rated their health as “fair” or “poor.” About one-third (30%) used one or more assistive ambulatory devices. About 15-20% of people who use assistive devices to ambulate report they do not have difficulty walking 0.25 miles.

b. Survey Response Analysis

A total of 1,595 individuals responded to the validation survey for an overall response rate of ˜12%. Those in ARCS Level 0 and who used fewer than 15 prescriptions were half as likely to respond (˜7%) than those in Level 2 or 3 (˜14%).

c. Using the Survey to Validate Predicted Clinical Intensity

Analysis was conducted on responses to questions on ADLs, IADLs, a problem list, CAHPS-Persons with Mobility Impairments (CAHPS-PWMI) test screeners on use of adaptive equipment, physical mobility, number of prescriptions and perceived public health. Respondents were clustered into four Levels corresponding to none, low, medium and high levels of clinical intensity. Other factors (such as age, gender, and entitlement status) were controlled.

Correct classification rates of the ARCS were computed using the survey self-report as the criterion standard. The sensitivity was found to be ˜99%, meaning it correctly identified about 99% of the people self-reporting impaired function. But, specificity was found to be ˜52%, meaning about half the people it identified as being impaired self-reported they were not.

The foregoing descriptions of the embodiments of the claimed invention have been presented for purposes of illustration and description. They are not intended to be exhaustive or be limiting to the precise forms disclosed, and obviously many modifications and variations are possible in light of the above teaching. The illustrated embodiments were chosen and described in order to best explain the principles of the claimed invention and its practical application to thereby enable others skilled in the art to best utilize it in various embodiments and with various modifications as are suited to the particular use contemplated without departing from the spirit and scope of the claimed invention. In fact, after reading the above description, it will be apparent to one skilled in the relevant art(s) how to implement the claimed invention in alternative embodiments. Thus, the claimed invention should not be limited by any of the above described example embodiments. For example, the claimed invention may be practiced over identifying prescription drug dosages, determining the areas of population potentially needing or requiring higher medical attention, etc.

In addition, it should be understood that any figures, graphs, tables, examples, etc., which highlight the functionality and advantages of the claimed invention, are presented for example purposes only. The architecture of the disclosed is sufficiently flexible and configurable, such that it may be utilized in ways other than that shown. For example, the steps listed in any flowchart may be reordered or only optionally used in some embodiments.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the claimed invention of the application. The Abstract is not intended to be limiting as to the scope of the claimed invention in any way.

Furthermore, it is the applicants' intent that only claims that include the express language “means for” or “step for” be interpreted under 35 U.S.C. § 112, paragraph 6. Claims that do not expressly include the phrase “means for” or “step for” are not to be interpreted under 35 U.S.C. § 112, paragraph 6.

A portion of the claimed invention of this patent document contains material which is subject to copyright protection. The copyright owner has no objection to the facsimile reproduction by anyone of the patent document or the patent invention, as it appears in the Patent and Trademark Office patent file or records, but otherwise reserves all copyright rights whatsoever.

What is claimed is:

1. A tangible computer readable medium encoded with instructions for classifying individuals with disabilities, executable by a machine under the control of a program of instructions, in which said machine includes a memory storing said program, wherein execution of said instructions by one or more processors causes said one or more processors to perform a multitude of steps comprising:
a. collecting medical data, said medical data including;
i. a person identifier; and
ii. at least one medical code, each of said medical code being associated with an access risk level;
b. aggregating said medical data around said person identifier, creating aggregated medical data; and
c. classifying said person identifier under a highest access risk level for each diagnosis within said aggregated medical data to determine a corresponding level of clinical service intensity by applying a data mining technique, said data mining technique using said access risk level associated with one or more records associated with said person identifier.

2. A tangible computer readable medium according to claim 1, wherein said medical code comprises a code from at least one of the following:
a. International Classification of Diseases code;
b. Current Procedural Terminology code;
c. Healthcare Common Procedure Coding System code;
d. National Drug Code; and
e. “no code”.

3. A tangible computer readable medium according to claim 2, wherein said access risk level is assigned to said medical code by processing said International Classification of Diseases code over a predetermined time period.

4. A tangible computer readable medium according to claim 2, wherein said access risk level is assigned to said medical code by processing said Current Procedural Terminology code over a predetermined time period.

5. A tangible computer readable medium according to claim 2, wherein said access risk level is assigned to said medical code by processing said Healthcare Common Procedure Coding System code over a predetermined time period.

6. A tangible computer readable medium according to claim 2, wherein said access risk level is assigned to said medical code by processing said National Drug Code over a predetermined time period.

7. A tangible computer readable medium according to claim 2, wherein said access risk level is assigned to said medical code by processing said “no code” over a predetermined time period.

8. A tangible computer readable medium according to claim 1, wherein said access risk level is assigned when more than a predetermined amount of predetermined codes is exceeded.

9. A tangible computer readable medium encoded with instructions for classifying individuals with disabilities, executable by a machine under the control of a program of instructions, in which said machine includes a memory storing said program, wherein execution of said instructions by one or more processors causes said one or more processors to perform a multitude of steps comprising:
a. collecting medical data from a database, said database including a multitude of records, each of said multitude of records including;
i. a person identifier; and
ii. at least one medical code, each of said medical code being associated with an access risk level;
b. aggregating said medical data around said person identifier, creating aggregated medical data;
c. classifying said person identifier into one of a multitude of said access risk level by applying a data mining technique, said data mining technique using said access risk level associated with one or more of said records associated with said person identifier; and
d. performing said data mining technique for each of said person identifier, said data mining technique including iterative steps comprising:
i. associating said access risk level with said medical code;
ii. grouping all of said records with the same said person identifier;
iii. determining a highest access risk level by using said “all of said records with the same said person identifier”; and
iv. associating said highest access risk level with said “same said person identifier”.

10. A tangible computer readable medium according to claim 9, wherein said medical code comprises a code from at least one of the following:
a. International Classification of Diseases code;
b. Current Procedural Terminology code;
c. Healthcare Common Procedure Coding System code;
d. National Drug Code; and
e. “no code”.

11. A method for classifying individuals with disabilities comprising:
a. collecting medical data, said medical data including;
i. a person identifier; and
ii. at least one medical code, each of said medical code being associated with an access risk level;
b. aggregating said medical data around said person identifier, creating aggregated medical data; and
c. classifying said person identifier under a highest access risk level for each diagnosis within said aggregated medical data to determine a corresponding level of clinical service intensity by applying a data mining technique, said data mining technique using said access risk level associated with one or more records associated with said person identifier.

12. A method according to claim 11, wherein said medical code comprises a code from at least one of the following:
a. International Classification of Diseases code;
b. Current Procedural Terminology code;
c. Healthcare Common Procedure Coding System code;
d. National Drug Code; and
e. “no code”.

13. A method according to claim 12, wherein said access risk level is assigned to said medical code by processing said International Classification of Diseases code over a predetermined time period.

14. A method according to claim 12, wherein said access risk level is assigned to said medical code by processing said Current Procedural Terminology code over a predetermined time period.

15. A method according to claim 12, wherein said access risk level is assigned to said medical code by processing said Healthcare Common Procedure Coding System code over a predetermined time period.

16. A method according to claim 12, wherein said access risk level is assigned to said medical code by processing said National Drug Code over a predetermined time period.

17. A method according to claim 12, wherein said access risk level is assigned to said medical code by processing said “no code” over a predetermined time period.

18. A method according to claim 11, wherein said access risk level is assigned when more than a predetermined amount of predetermined codes is exceeded.

19. A system for classifying individuals with disabilities comprising:
a. a medical data collector configured for collecting medical data, said medical data including;
i. a person identifier; and
ii. at least one medical code, each of said medical code being associated with an access risk level;
b. a medical data aggregator configured for aggregating said medical data around said person identifier, creating aggregated medical data; and
c. a medical data classifier configured for classifying said person identifier under a highest access risk level for each diagnosis within said aggregated medical data to determine a corresponding level of clinical service intensity by applying a data mining technique, said data mining technique using said access risk level associated with one or more records associated with said person identifier.

20. A system according to claim 19, wherein said medical code comprises a code from at least one of the following:
a. International Classification of Diseases code;
b. Current Procedural Terminology code;
c. Healthcare Common Procedure Coding System code;
d. National Drug Code; and
e. “no code”.
